(19) United States
(12) Patent Application Publication
(10) Pub. No.: US 2021/0330084 A1
(43) Pub. Date: Oct. 28, 2021

(54) FOLDABLE SEAT CUSHION

(71) Applicant: GYMWELL CO., LTD., Tainan City (TW)

(72) Inventor: TIEN-MING CHEN, TAINAN CITY (TW)

(21) Appl. No.: 16/857,371

(22) Filed: Apr. 24, 2020

(51) Int. Cl. A47C 7/02; A61H 7/00

(52) U.S. Cl. CPC A47C 7/021; A61H 2201/0149; A61H 7/002; A47C 7/029

(57) ABSTRACT

The present invention discloses a foldable seat cushion which comprises a first cushion body at a front region thereof, a second cushion body at a back region thereof opposite to the first cushion body and having a lower spine supporting portion, at least one third cushion body disposed between the first cushion body and the second cushion body, and at least one folding member for connecting the at least one third cushion body to the first cushion body and the second cushion body.

### BACKGROUND OF THE INVENTION

### 1. Field of the Invention

The present invention relates to a foldable seat cushion for effective correction of a user's poor posture, carrying and storage with ease owing to its small volume in a folded state.

### 2. Description of Related Art

A person staying at home or working in an office usually sits on a chair with poor posture for a long time, which possibly leads to a range of adverse health effects. If siting on a chair with poor posture for a long time, it will put people at a higher risk of developing and causing low back pain, lower limb numbness and permanent health issues such as spine flexion and kyphosis. In addition, a conventional chair cushion is usually made of foam material stuffed within a surface cloth to improve comfort while sitting. However, body heat of a user is diffused to and absorbed by the foam material within the surface cloth and is not easily dissipated. Therefore, the user will feel hot, stuffy and uncomfortable after sitting on the chair for a period of time.

### SUMMARY OF THE INVENTION

The present invention discloses a foldable seat cushion for effective correction of a user's poor posture as well as improvement on health issues, such as spine flexion and kyphosis caused by poor posture. The present invention is also easy to carry and store due to its small volume after being folded. In addition, the present invention also prevents the user from lower limb numbness and feeling hot and stuffy.

The foldable seat cushion of the present invention comprises a first cushion body, a second cushion body, at least one third cushion body and at least one folding member. The first cushion body is disposed at a front region of the foldable seat cushion, the second cushion body is disposed at a back region of the foldable seat cushion opposite to the first cushion body, and the at least one third cushion body is disposed at each of two lateral regions of the foldable seat cushion and between the first cushion body and the second cushion body. The at least one third cushion body is connected to the first cushion body and the second cushion body by the at least one folding member. In addition, the second cushion body has a lower spine supporting portion. Accordingly, when a user is sitting on the foldable seat cushion of the present invention, the spine including the sacrum of the user is supported by the lower spine supporting portion of the second cushion body which straightens the spine of the user naturally. Therefore, the user has a correct sitting position by using the present invention so as to prevent low back pain and health issues such as spine flexion and kyphosis. Furthermore, the at least one third cushion body and the first cushion body can be sequentially folded and disposed under the second cushion body for storage when the present invention is not in use, so the effects of saving space, carrying and storing with ease are achieved.

### BRIEF DESCRIPTION OF THE DRAWINGS

FIG. 1 is an exploded diagram showing a foldable seat cushion of the present invention;

FIG. 2 is a stereogram showing a foldable seat cushion of the present invention;

FIG. 3 is a first sectional diagram showing a foldable seat cushion of the present invention;

FIG. 4 is a second sectional diagram showing a foldable seat cushion of the present invention;

FIG. 5 is a first schematic diagram showing a foldable seat cushion of the present invention in use;

FIG. 6 is a schematic diagram showing a foldable seat cushion of the present invention in a folded state;

FIG. 7 is a second schematic diagram showing a foldable seat cushion of the present invention in use.

### DETAILED DESCRIPTION OF THE PREFERRED EMBODIMENT

First, the words “front” and “back” in the description of the present invention are used for describing the specific structure of the present invention more clearly and are not used to limit the direction of the present invention.

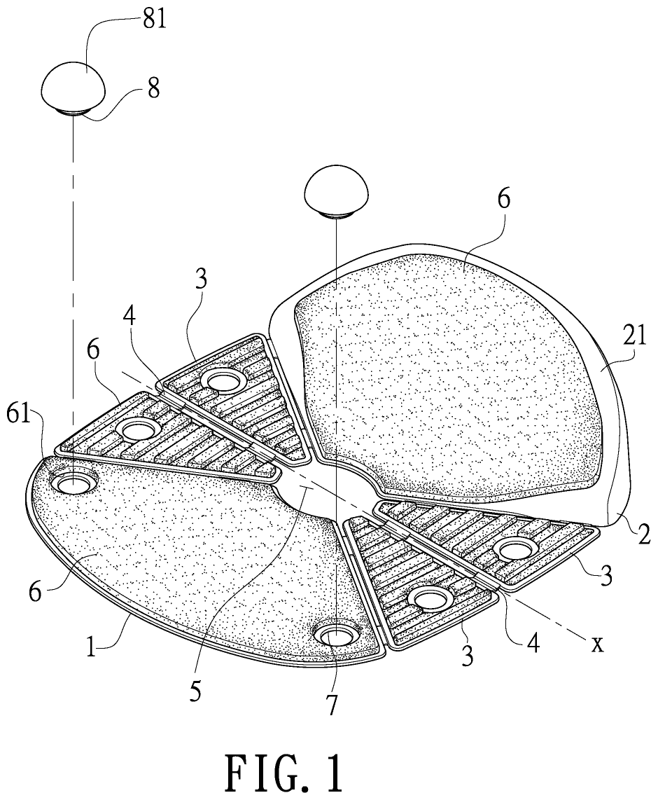

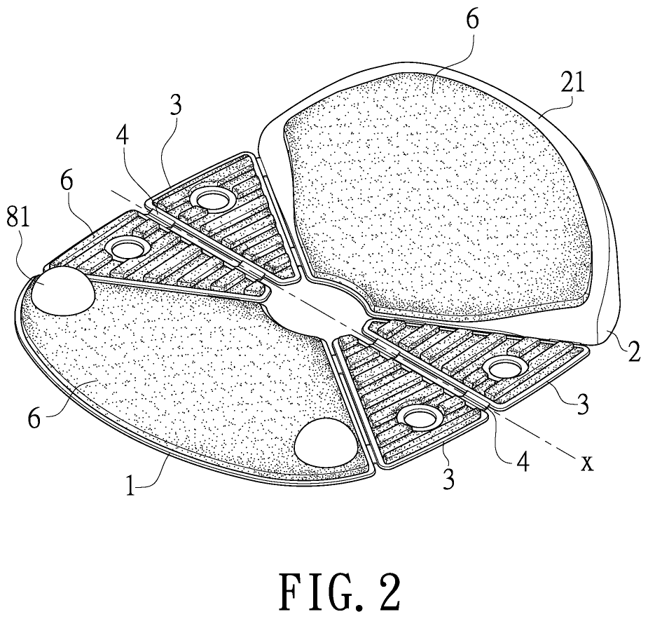

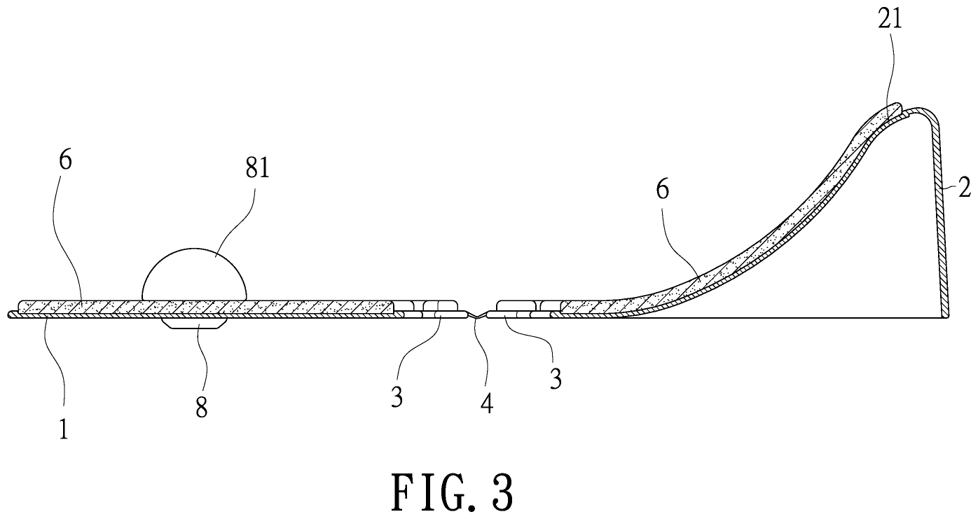

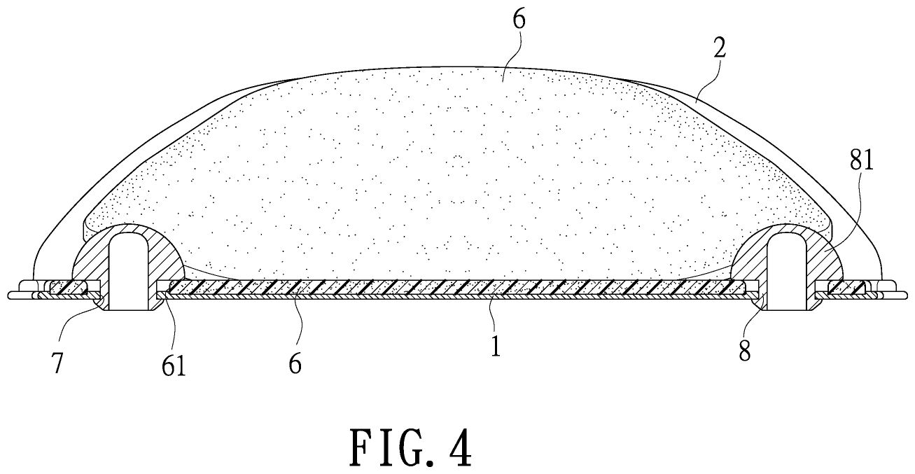

Referring to FIG. 1 to FIG. 4, a foldable seat cushion of the present invention is divided into a front region, a back region opposite the front region, and two lateral regions between the front region and the back region. The foldable seat cushion of the present invention comprises a first cushion body (1) disposed at the front region, a second cushion body (2) disposed at the back region opposite to the first cushion body (1), at least one third cushion body (3) disposed between the first cushion body (1) and the second cushion body (2), and at least one folding member (4) for connecting the at least one third cushion body (3) to the first cushion body (1) and the second cushion body (2). The second cushion body (2) has a lower spine supporting portion (21) gradually inclined upwardly from a first side thereof adjacent to the first cushion body (1) to a second side thereof opposite to the first side. And the at least one folding member (4) can be a hinge or a connecting piece in which the connecting piece is made by an injection modeling process together with the first cushion body (1), the second cushion body (2) and the at least one third cushion body (3) as an integral.

The at least one third cushion body (3) is disposed at each of the two lateral regions of the present invention for connecting the first cushion body (1) and the second cushion body (2), and a hollow area (5) is defined by the first cushion body (1), the second cushion body (2) and the at least one third cushion body (3). In a preferred embodiment of the present invention, two of the third cushion bodies (3) are disposed at each of the two lateral regions of the present invention, and the two third cushion bodies (3) are connected by a folding member (4). The two third cushion bodies (3) have a symmetric shape with respect to an axis (X) of each of the two lateral regions where the at least one folding member (4) is located.

In addition, each of the first cushion body (1), the second cushion body (2) and the at least one third cushion body (3) has a soft pad (6) on a top thereof, and the soft pad (6) is made of a rubber material or a silicone material. Each of the first cushion body (1) and the at least one third cushion body (3) is provided with at least one first through hole (7), and each of the soft pads (6) on the first cushion body (1) and the at least one third cushion body (3) is provided with at least one second through hole (61) corresponding to the at least one first through hole (7). The second through hole (61) has a larger diameter than the first through hole (7) has. The present invention further comprises at least one massage element (8). The at least one massage element (8) is inserted into the at least one first through hole (7) of the first cushion body (1) and the at least one third cushion body (3) respectively. Each of the at least one massage element (8) has a block (81) at a top thereof protruding from the first though hole (7) and the second through hole (61).

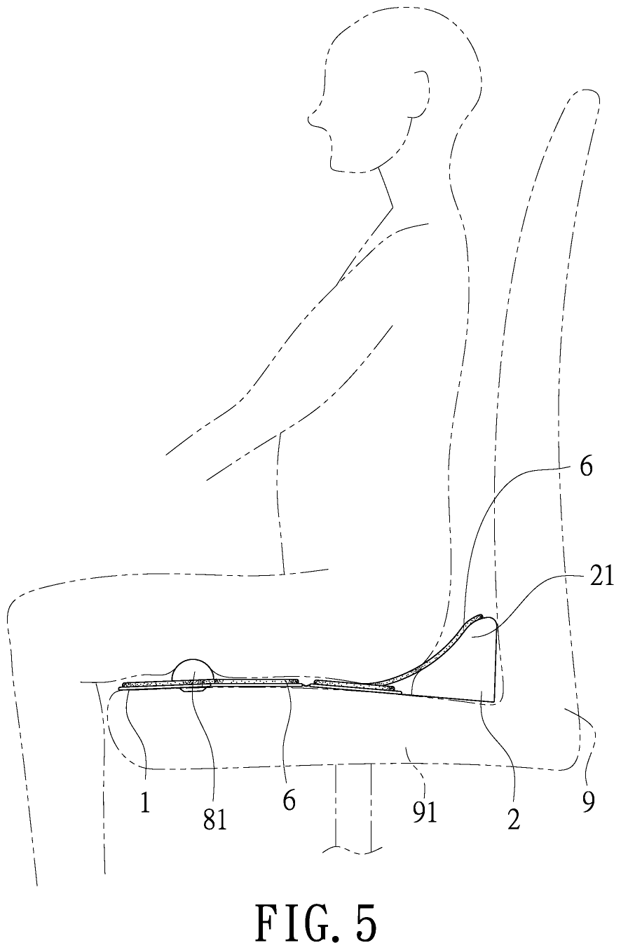

Referring to FIG. 5, when using the present invention, the foldable seat cushion of the present invention is placed on a chair seat (91) of a chair (9) in an unfolded state, and then a user is sitting on the present invention. When using the present invention, the user is sitting on the second cushion body (2) by the hip, and the user's thighs and the joint areas of the hip and the thighs are contacted against the first cushion body (1) and the at least one third cushion body (3). The user's lower part of the spine including the coccyx and sacrum is supported and straightened naturally by the lower spine supporting portion (21) of the second cushion body (2). Therefore, the user has a correct sitting position by using the present invention so as to prevent low back pain and health issues such as spine flexion and kyphosis.

Furthermore, the user's lower limbs including the thigh are pressed on the block (81) of the at least one massage element (8) protruding from the first cushion body (1) and the at least one third cushion body (3) when sitting on the present invention in which the user's lower limbs are massaged by the at least one massage element (8). So the present invention also prevents the user from lower limb numbness. The soft pads (6) disposed on the first cushion body (1), the second cushion body (2) and the at least one third cushion body (3) can improve comfortability of the user sitting on the present invention. In addition, the user's hip and thighs are also insulated by the present invention from the chair seat (91) of the chair (9) to prevent diffusing of the user's body heat to a foam material within the chair seat (91) directly. Then, the user's body heat is not adsorbed by the foam material so as to decrease a hot and stuffy feeling caused by the body heat. The user's body heat is dissipated by the hollow area (5) defined by the first cushion body (1), the second cushion body (2) and the at least one third cushion body (3). The user's body heat is also dissipated by plural gaps at the connection regions of the first cushion body (1), the second cushion body (2) and the at least one third cushion body (3). Therefore, the present invention increases coolness and comfortability to the user sitting thereon.

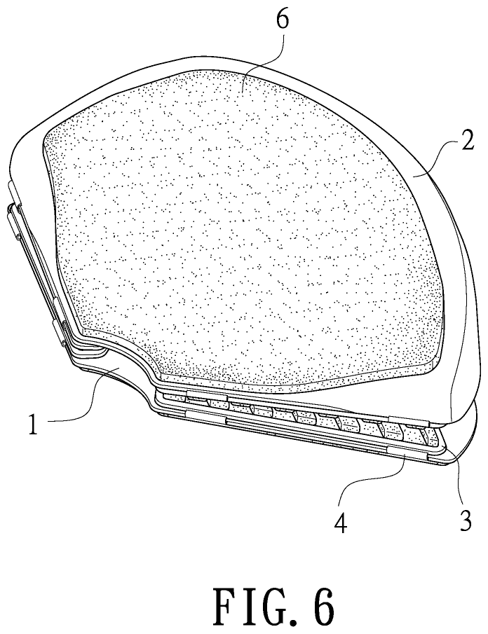

Please referring to FIG. 6, since the first cushion body (1), the second cushion body (2) and the at least one third cushion body (3) are connected by the folding member (4), the at least one third cushion body (3) and the first cushion body (1) can be sequentially folded and disposed under the second cushion body (2) when the present invention is not in use. Therefore, the present achieves effects of saving space, carrying and storing with ease.

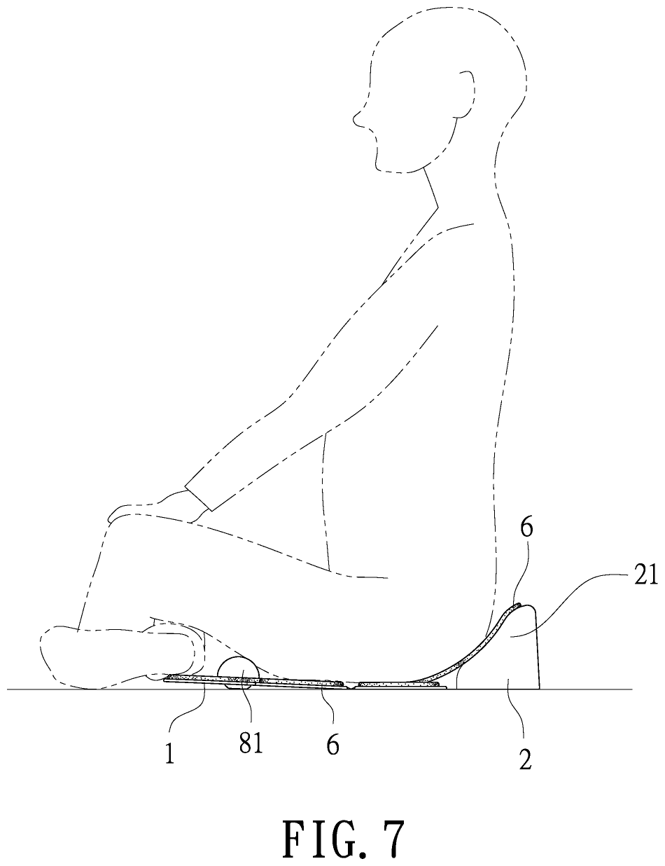

Please referring to FIG. 7, in addition to being place on the chair seat (91) of the chair (9), the present invention can also be placed on a floor, a tatami or a lawn directly when a chair is not available and the user can sit on the present invention as sitting on a chair. In another embodiment, the soft pads (6) on the first cushion body (1), the second cushion body (2) and the at least one third cushion body (3) are omitted. The at least one massage element (8) is inserted into the at least one first through hole (7) of the first cushion body (1) and the at least one third cushion body (3) and each of the block (81) of the at least one massage element (8) is protruded from the first through hole (7) to massage the thighs of the user.

According to the embodiments above, the present invention has advantages as follows:

1. The second cushion body of the present invention has a lower is spine supporting portion gradually inclined upwardly from a first side to a second side of the second cushion body which supports the sacrum of the user sitting thereon and straightens the spine of the user naturally. So the user has a correct sitting position by using the present invention so as to prevent low back pain and health issues such as spine flexion and kyphosis.

2. The foldable seat cushion of the present invention comprises at least one massage element which is inserted into the at least one first through hole of each of the first cushion body and the at least one third cushion body randomly as needed. The user's thighs are pressed on and massaged by the massage element when sitting on the present invention to avoid limb numbness caused by sitting for a long time.

3. The first cushion body, the second cushion body and the at least one third cushion body of the foldable seat cushion of the present invention are connected by a folding member, and the at least one third cushion body and the first cushion body can be folded under the second cushion body when the present invention is not in use. So the present invention achieves effects of saving space, carrying and storing with ease.

4. The foldable seat cushion of the present invention is laid on the chair seat of the chair and insulates the user's hip and thighs from the chair seat. Thus, the present invention prevents the user feeling hot and stuffy since the user's body heat is not diffused directly to a foam material stuffed within the chair seat. Furthermore, the user's body heat is dissipated by the hollow area defined by the first cushion body, the second cushion body and the at least one third cushion body and by the plural gaps at the connection regions of the three cushion bodies to improve comfortability.

5. The foldable seat cushion of the present invention also comprises soft pads on the first cushion body, the second cushion body and the third cushion body which improve comfortability of the user.

6. The foldable seat cushion of the present invention can be placed directly on a floor, a tatami and a lawn when a chair in not available, and the user can sit on the present invention as sitting on a chair.

What is claimed is:

1. A foldable seat cushion, comprising:
a first cushion body;
a second cushion body opposite to the first cushion body and having a lower spine supporting portion gradually inclined upwardly from a first side thereof adjacent to the first cushion body to a second side thereof opposite to the first side;
at least one third cushion body disposed between the first cushion body and the second cushion body; and
to at least one folding member for connecting the at least one third cushion body to the first cushion body and the second cushion body.

2. The foldable seat cushion as claimed in claim 1, being divided into a front region, a back region opposite to the front region and two lateral regions between the front and back regions, wherein the first cushion body and the second cushion body are respectively disposed at the front region and the back region thereof, and the at least one third cushion body is equally disposed at each of the two lateral regions thereof for connecting the first cushion body and the second cushion body.

3. The foldable seat cushion as claimed in claim 2, wherein a hollow area is defined by the first cushion body, the second cushion body and the at least one third cushion body.

4. The foldable seat cushion as claimed in claim 2, wherein the two third cushion bodies at each of the two lateral regions thereof are connected by the at least one folding member and have a symmetric shape with respect to an axis of each of the two lateral regions where the at least one folding member is located.

5. The foldable seat cushion as claimed in claim 1, wherein each of the first cushion body, the second cushion body and the at least one third cushion body has a soft pad on a top thereof.

6. The foldable seat cushion as claimed in claim 5, wherein each of the first cushion body and the at least one third cushion body is provided with at least one first through hole, and each of the soft pads on the first cushion body and the at least one third cushion body is provided with at least one second through hole corresponding to the at least one first through hole.

7. The foldable seat cushion as claimed in claim 6, further comprising at least one massage element for inserting into the at least one first through hole of the first cushion body and the at least one third cushion body respectively, and wherein each of the at least one massage element has a block at a top thereof protruding from the first though hole and the second through hole.

8. The foldable seat cushion as claimed in claim 1, wherein each of the first cushion body and the at least one third cushion body is provided with at least one first through hole.

9. The foldable seat cushion as claimed in claim 8, further comprising at least one massage element for inserting into the at least one first through hole of the first cushion body and the at least one third cushion body respectively, and wherein each of the at least one massage element has a block at a top thereof protruding from the first though hole and the second through hole.

10. The foldable seat cushion as claimed in claim 1, wherein the at least one folding member is a hinge or a connecting piece.
